(19) United States
(12) Patent Application Publication
(10) Pub. No.: US 2007/0027668 A1
(43) Pub. Date: Feb. 1, 2007

(54) Signal simulator for generating a string of user input signals to stimulate redundant operation of a user input device of a computerized apparatus

(76) Inventor: Kenny Chen, Chang-Hua Hsien (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/183,610

(22) Filed: Jul. 18, 2005

(51) Int. Cl. G06F 17/50

(52) U.S. Cl. 703/13

(57) ABSTRACT

A signal simulator is adapted for use with a computerized apparatus having a user input device that generates user input signals upon operation of the user input device, and includes a storage unit for storing program code data associated with target user input signals of the user input device. An interface unit is adapted to establish a data transmission path with the computerized apparatus. A control unit is connected electrically to the storage unit and the interface unit, and is operable so as to generate a string of simulated user input signals corresponding to the program code data in the storage unit and so as to provide the simulated user input signals to the computerized apparatus via the interface unit, thereby enabling the computerized apparatus to make a response corresponding to the target user input signals.

### BACKGROUND OF THE INVENTION

1. Field of the Invention

The invention relates to a signal simulator, more particularly to a signal simulator for generating a string of user input signals to simulate redundant operation of a user input device of a computerized apparatus.

2. Description of the Related Art

For a computerized apparatus, such as a computer device, a keyboard and a computer mouse are the most common user input devices. With the development of the Internet, redundant manual operation for the keyboard and/or the computer mouse may be required while using the computerized apparatus, thereby resulting in inconvenience. For example, during playing an on-line game, frequent and redundant manual operations for the user input device can cause injury to the hands of the user. In order to reduce the number of manual operations for the user input device, it has been proposed heretofore to provide program code data associated with target user input signals of the user input device so that the redundant operations are performed with minimum user intervention.

However, if the above program code data is stored in a hard disk of the computerized apparatus, unauthorized copying of the program code data cannot be avoided, such that copyright protection for the software developer cannot be ensured.

### SUMMARY OF THE INVENTION

Therefore, the object of the present invention is to provide a signal simulator that can generate a string of user input signals for simulating redundant operation of a user input device of a computerized apparatus.

According to the present invention, there is provided a signal simulator adapted for use with a computerized apparatus having a user input device that generates user input signals upon operation of the user input device. The signal simulator comprises:

a storage unit for storing program code data associated with target user input signals of the user input device;

an interface unit adapted to establish a data transmission path with the computerized apparatus; and a control unit connected electrically to the storage unit and the interface unit, the control unit being operable so as to generate a string of simulated user input signals corresponding to the program code data in the storage unit and so as to provide the simulated user input signals to the computerized apparatus via the interface unit, thereby enabling the computerized apparatus to make a response corresponding to the target user input signals.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating the preferred embodiment of a signal simulator according to the present invention; and

FIG. 2 is a schematic view showing the preferred embodiment.

### DETAILED DESCRIPTION OF THE PREFERRED EMBODIMENT

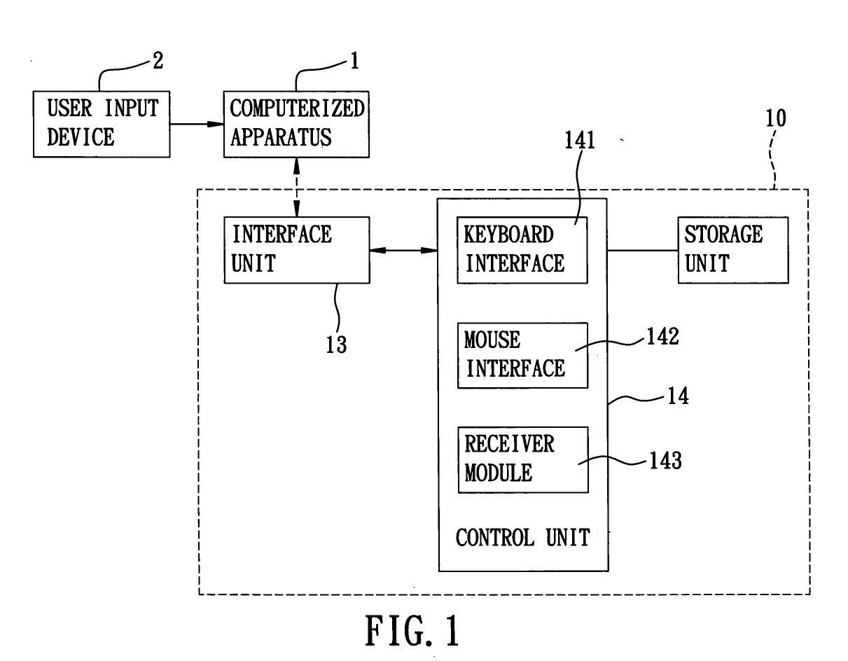

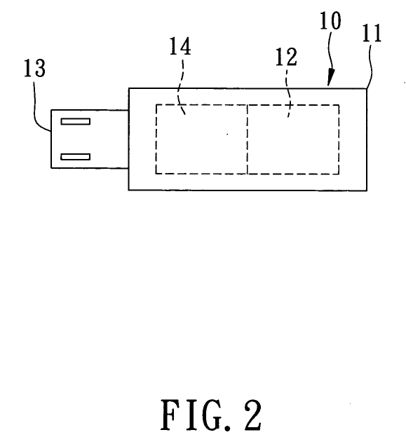

Referring to FIGS. 1 and 2, the preferred embodiment of a signal simulator 10 according to the present invention is shown to be adapted for use with a computerized apparatus 1, such as a personal computer, having a user input device 2 that generates user input signals upon operation of the user input device 2. In this embodiment, the user input device 2 is at least one of a keyboard and a computer mouse. The signal simulator 10 is adapted to be externally connected to the computerized apparatus 1, and includes a storage unit 12, an interface unit 13, a control unit 14, and a portable housing 11.

In this embodiment, the storage unit 12 is in the form of a storage chip for storing proprietary program code data associated with target user input signals of the user input device 2, i.e., the program code data is associated with the target user input signals of at least one of the keyboard and the computer mouse. In this embodiment, the target user input signals are associated with a predetermined redundant operation of the user input device 2 (i.e., the keyboard and/or the computer mouse).

The interface unit 13 is adapted to establish a data transmission path with the computerized apparatus 1. In this embodiment, the interface unit 13 includes an external data bus that has a specification selected from the group consisting of USB, PS/2, IEEE 1394 and RS-232.

The control unit 14 is connected electrically to the storage unit 12 and the interface unit 13. The control unit 14 is operable so as to generate a string of simulated user input signals corresponding to the program code data in the storage unit 12 and so as to provide the simulated user input signals to the computerized apparatus 1 via the interface unit 13, thereby enabling the computerized apparatus 1 to make a response corresponding to the target user input signals. In this embodiment, the control unit 14 includes a keyboard interface 141 and a computer mouse interface 142 such that the simulated user input signals conform to standard keyboard and/or computer mouse signals. The control unit 14 further includes a receiver module 143 that is adapted for receiving an enable signal from the computerized apparatus 1 through the interface unit 13 as a result of operation of the user input device 2. The control unit 14 generates a finite string of the simulated user input signals in response to the enable signal. Alternatively, the control unit 14 can be configured to generate the simulated user input signals upon detection of the data transmission path established by the interface unit 13 with the computerized apparatus 1 without the need for the aforesaid enable signal. It is noted that, due to the presence of the keyboard and computer mouse interfaces 141, 142, the control unit 14 can provide the simulated user input signals to the computerized apparatus 1 even when the user input device 2 is disconnected from the computerized apparatus 1.

As shown in FIG. 2, the portable housing 11 houses the storage unit 12 and the control unit 14 therein. The interface unit 13 is mounted on the portable housing 11.

For example, the target user input signals corresponding to the program code data are directed to simulate 360°-shooting control for a specific character in an online role-playing game via operation of the user input device 2. Therefore, when the signal simulator 10 is coupled to the computerized apparatus 1, a string of simulated user input signals associated with the 360°-shooting control for the specific character is provided to the computerized apparatus 1 after the receiver module 143 of the control unit 14 receives an enable signal generated by pressing a specified key of the keyboard, such as the “Scroll Lock” key. As such, the computerized apparatus 1 enables a response corresponding to the target user input signals without the need for further operation of the user input device 2. Accordingly, because redundant operation of the user input device 2 can be reduced, possible injury to the user's hands as a result of redundant operation of the user input device 2 can be minimized as well.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A signal simulator adapted for use with a computerized apparatus having a user input device that generates user input signals upon operation of the user input device, said signal simulator comprising:
a storage unit for storing program code data associated with target user input signals of the user input device;
an interface unit adapted to establish a data transmission path with the computerized apparatus; and
a control unit connected electrically to said storage unit and said interface unit, said control unit being operable so as to generate a string of simulated user input signals corresponding to said program code data in said storage unit and so as to provide the simulated user input signals to the computerized apparatus via said interface unit, thereby enabling the computerized apparatus to make a response corresponding to the target user input signals.

2. The signal simulator as claimed in claim 1, wherein said interface unit includes an external data bus.

3. The signal simulator as claimed in claim 2, wherein said interface unit has a specification selected from the group consisting of USB, PS/2, IEEE 1394 and RS-232.

4. The signal simulator as claimed in claim 1, the user input device being at least one of a keyboard and a computer mouse, wherein said program code data is associated with target user input signals of at least one of the keyboard and the computer mouse.

5. The signal simulator as claimed in claim 1, the user input device being a keyboard, wherein said program code data is associated with target user input signals of the keyboard, said control unit including a keyboard interface such that the simulated user input signals conform to standard keyboard signals.

6. The signal simulator as claimed in claim 1, the user input device being a computer mouse, wherein said program code data is associated with target user input signals of the computer mouse, said control unit including a mouse interface such that the simulated user input signals conform to standard computer mouse signals.

7. The signal simulator as claimed in claim 1, wherein said control unit includes a receiver module adapted for receiving an enable signal from the computerized apparatus through said interface unit, said control unit generating the simulated user input signals in response to the enable signal.

8. The signal simulator as claimed in claim 1, wherein said control unit generates the simulated user input signals upon detection of the data transmission path established by said interface unit with the computerized apparatus.

9. The signal simulator as claimed in claim 1, wherein the target user input signals are associated with a predetermined redundant operation of the user input device.

10. The signal simulator as claimed in claim 1, further comprising a portable housing for housing said storage unit and said control unit therein, said interface unit being mounted on said portable housing.
